(19) United States
(12) Patent Application Publication
(10) Pub. No.: US 2013/0276757 A1
(43) Pub. Date: Oct. 24, 2013

(54) ROTARY RECIPROCATING PISTON ENGINE

(71) Applicant: John McIntyre, Traverse City, MI (US)

(72) Inventor: John McIntyre, Traverse City, MI (US)

(21) Appl. No.: 13/451,926

(22) Filed: Apr. 20, 2012

(51) Int. Cl. F02B 75/26

(52) U.S. Cl. 123/45 R

(57) ABSTRACT

This internal combustion engine utilizes a rotary piston motion simultaneously having an upward and downward stroke to facilitate a power output. In comparison to existing engines, this engine possesses fewer parts, has enhanced fuel economy and performance, and is capable of using alternative fuels. The drive shaft is connected directly to the piston and a fixed arm is attached to the driveshaft. The fixed arm has a rotating bushing traversing upon an inclined bearing surface to allow rotary and reciprocating motion of the piston.

### CROSS-REFERENCE TO RELATED APPLICATIONS

The present non-provisional patent application does not claim the benefit of priority of any U.S. provisional and/or non-provisional patent applications.

### STATEMENT OF FEDERALLY SPONSORED RESEARCH/DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF INVENTION

This invention relates to internal combustion engines and in particular, to an engine which utilizes a piston having rotary motion simultaneously with an upward and downward stroke.

### BACKGROUND OF THE INVENTION

A new version of the internal combustion engine is needed. A viable option for many commercial and industrial applications goes unaddressed such as decreased volumetric efficiency associated with alternative fuels. Furthermore, an engine with the benefits of the rotary (Wankel type) engine without the rotor sealing issues and resultant parts would be welcome.

The invention is an internal combustion engine that can have single or multiple power cycles per piston rotation and incorporate alternative fuels when needed. The engine can be manufactured for lightweight high-performance applications. Conversely, it can be made for low power applications as well due to its versatility.

### BRIEF SUMMARY OF THE INVENTION

The invention provides an internal combustion engine of simple design with fewer parts and ease of manufacture, low maintenance and adaptability to a variety of fuel sources. The engine components cause less internal friction and by design increase power output while consuming less fuel.

These and other features and advantages of the invention will become apparent from the detailed description below, in light of the accompanying drawings.

### BRIEF DESCRIPTION OF THE SEVERAL VIEWS OF THE DRAWINGS

FIG. 1 is a cross-section view of the invention showing the components with pistons at TDC (Top Dead Center) and BDC (Bottom Dead Center).

FIG. 2 is a partial perspective view showing the driveshaft fixed arm and relationship to the inclined bearing surface.

For purposes of clarity and brevity, like elements and components will bear the same designations and numbering throughout the Figures.

### DETAILED DESCRIPTION OF THE INVENTION

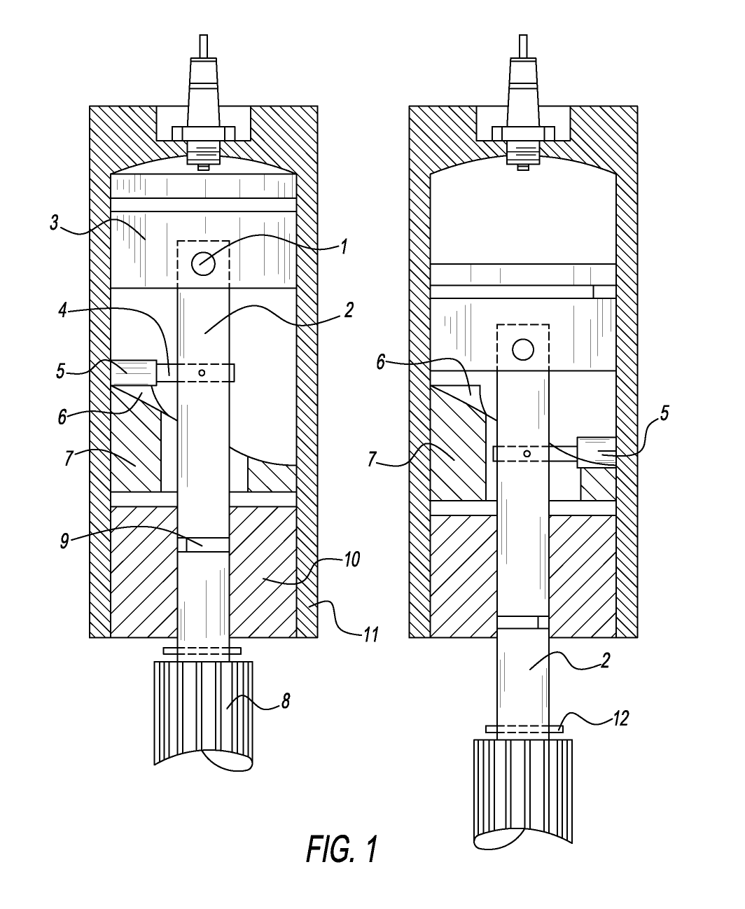

Looking at FIG. 1, a wrist pin (1) is shown connecting the driveshaft (2) to the piston (3). The driveshaft (2) has a fixed arm (4) attached. If the fixed arm is attached to the driveshaft by drilling and tapping, be aware that driveshaft rotation, either counterclockwise or clockwise, determines whether to use either right-hand or left-hand threads to prevent the arm from loosening during operation causing internal engine damage. The fixed arm (4) has a rotating bushing (5) traversing upon the parallel inclined bearing surface (6) of the sleeve (7). An open needle-roller bearing could be substituted for the bushing. Lubrication is dependent upon adaptation of the engine to the cycles of either four-stroke or two-stroke being either oil circulation in the area below the piston or the mixture of fuel and oil in the later. Likewise, valve trains and/or porting are not shown since these can be incorporated into the design by one skilled in the art. The driveshaft (2) is shown with a gear (8) and machined for a compressed sealing ring (9) placed to prevent leakage of either oil or fuel/oil mixture. The driveshaft (2) is guided thereby a bushing (10) fitted into the working cylinder (11). A linear rotary style bearing could be substituted for this bushing. The invention eliminates many of the components used in both conventional internal combustion engines and rotary type engines. Overall, this increases efficiency, decreases friction, and enhances performance and fuel economy.

Again referring to FIG. 1, which displays the invention showing both the piston at TDC and BDC. The rotating bushing (5) contacts the inclined bearing surface (6) of the sleeve (7) during each 360° piston rotation. Continuous contact is maintained from compression and combustion forces exerted on the piston along with rotational forces. As a safety measure, to prevent piston travel beyond TDC, provisions such as a pin (12) can be made to the driveshaft (2).

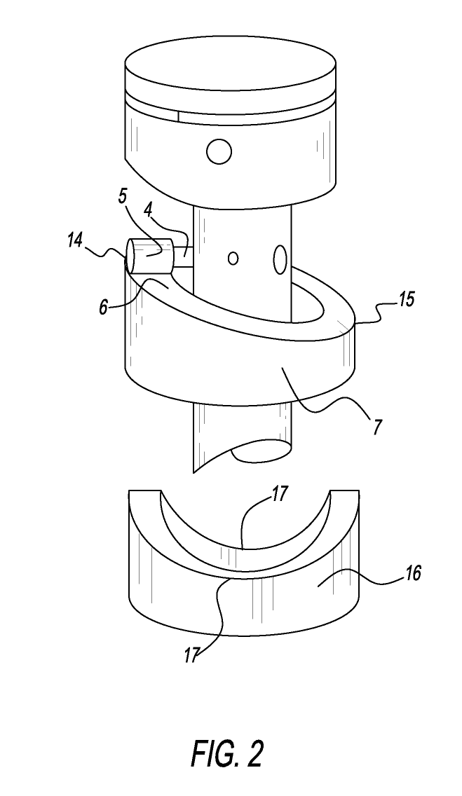

FIG. 2 provides close up detail of the driveshaft with fixed arm (4), its rotating bushing (5), and the inclined bearing surface (6), a feature of the sleeve (7). The inclined bearing surface working height determines the piston stroke. The working height is defined as the vertical difference of the top (14) and bottom (15) of the inclined bearing surface. The sleeve can be made to adjust upward or downward for varying the engine compression ratio. Means to make this adjustment can range from a set screw holding the sleeve in place after drifting it up or down or incorporating a mechanism. The sleeve can be removed and replaced with another sleeve to compensate for volumetric efficiency of various combustible fuels. For example, simply substituting an engine with a sleeve having an inclined bearing surface that creates a longer stroke could be used to compensate for low BTU fuels. Also shown is a modified sleeve (16) with an inclined bearing surface (17) that allows multiple power strokes every piston rotation.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of the invention.

Having thus described the invention, what is desired to be protected by Letters Patent is presented in the subsequently appended claims.

I claim:

1. A rotary reciprocating piston engine comprising:
means for power output; and
means for facilitating the rotary reciprocating movement of the piston.

2. The rotary reciprocating piston engine in accordance with claim 1, wherein said means for power output comprises the driveshaft connected to the piston.

3. The rotary reciprocating piston engine in accordance with claim 1, wherein said means for facilitating the rotary reciprocating movement of the piston comprises a fixed arm attached to the driveshaft having a rotating member contacting an inclined bearing surface.

4. The rotary reciprocating piston engine in accordance with claim 3, wherein said inclined bearing surface is a feature of the sleeve.

5. The rotary reciprocating piston engine in accordance with claim 4, wherein said sleeve can be made to adjust upward or downward for varying the engine compression ratio.

6. The rotary reciprocating piston engine in accordance with claim 4, wherein said sleeve can be removed and refitted with another sleeve to compensate for volumetric efficiency of various combustible fuels.

7. The rotary reciprocating piston engine in accordance with claim 4, wherein said sleeve is modified with an inclined bearing surface allowing multiple strokes per piston revolution.

8. The rotary reciprocating piston engine in accordance with claim 2, wherein said driveshaft is equipped with a stop to prevent internal engine damage in the event of the piston exceeding TDC.
